(19) United States
(12) Patent Application Publication
(10) Pub. No.: US 2021/0053364 A1
(43) Pub. Date: Feb. 25, 2021

(54) METHOD OF DETECTING DISCHARGE ABNORMALITY IN NOZZLES OF INKJET RECORDING DEVICE AND INKJET RECORDING DEVICE

(71) Applicant: KYOCERA Document Solutions Inc., Osaka (JP)

(72) Inventor: Yuichiro KUROKAWA, Osaka (JP)

(73) Assignee: KYOCERA Document Solutions Inc., Osaka (JP)

(21) Appl. No.: 16/998,887

(22) Filed: Aug. 20, 2020

(30) Foreign Application Priority Data
Aug. 22, 2019 (JP) 2019-152052

(51) Int. Cl. B41J 2/21; B41J 29/393; H04N 1/00

(52) U.S. Cl. CPC B41J 2/2146; B41J 2/2142; H04N 2201/0082; H04N 1/00039; B41J 29/393

(57) ABSTRACT

In the check pattern of a check chart, among a plurality of ink discharge nozzles, a predetermined number of ink discharge nozzles in a main scanning direction are set to one block, and in each of the blocks, a plurality of check lines which are recorded by the one block and which are extended along a subscanning direction are drawn such that each time the check lines proceed a predetermined length in the subscanning direction, the check lines are sequentially shifted line by line in the main scanning direction. In the line detection step, a detection range is sequentially moved by the one block in the main scanning direction, whether or not the check line is present is detected and based on the position of the detected check line within the one block in the main scanning direction, the moved position of the subsequent block is corrected.

### INCORPORATION BY REFERENCE

This application is based upon and claims the benefit of priority from the corresponding Japanese Patent Application No. 2019-152052 filed on Aug. 22, 2019, the entire contents of which are incorporated herein by reference.

### BACKGROUND

The present disclosure relates to a method of detecting a discharge abnormality in the nozzles of an inkjet recording device and an inkjet recording device which uses the method of detecting a discharge abnormality in the nozzles.

In an inkjet recording device, in order to continue high-quality recording, it is necessary to appropriately monitor non-discharge in ink discharge nozzles provided in a recording head. Hence, an inkjet recording device is proposed in which a check chart formed with a predetermined pattern image is recorded on a sheet (recording medium), in which whether or not inks are present in the check chart is detected and in which thus a non-discharge nozzle among ink discharge nozzles is grasped.

For example, in a conventional inkjet recording device, the result of reading of an image recorded with a recording head with an optical portion including an imaging element and a lens is compared with a threshold value, and thus the state of the recording head or the image is analyzed. Here, in the inkjet recording device, based on an index indicating the contrast performance of the optical portion in each of divided reading regions obtained by dividing a reading region into a plurality of regions, the threshold value is corrected in each of the divided reading regions. In this way, it is possible to analyze the state of a printed image (non-discharge detection pattern) without being affected by variations in the performance of the optical portion.

### SUMMARY

A method of detecting a discharge abnormality in the nozzles of an inkjet recording device according to one aspect of the present disclosure includes a chart recording step, a chart reading step and a discharge abnormality detection step. The chart recording step is to make a plurality of ink discharge nozzles arranged to be aligned along a main scanning direction in a recording head perform an operation of discharging an ink so as to record, on a recording medium, a check chart including a check pattern which is drawn with only the ink discharge nozzles. The chart reading step is to read, with detection elements, the check chart recorded on the recording medium. The discharge abnormality detection step is to determine an abnormality in the ink discharge nozzles by whether or not the check pattern is drawn in the image data of the check chart read from the recording medium. In the check pattern of the check chart, among the ink discharge nozzles, a predetermined number of ink discharge nozzles in the main scanning direction are set to one block, and in each of the blocks, a plurality of check lines each of which is recorded with one of the ink discharge nozzles and which are extended along a subscanning direction are drawn such that each time the check lines proceed a predetermined length in the subscanning direction, the check lines are sequentially shifted line by line in the main scanning direction. The discharge abnormality detection step includes a line detection step of detecting, by the one block, with the detection elements, whether or not the check line in the check pattern is present. In the line detection step, a detection range is sequentially moved by the one block in the main scanning direction, whether or not the check line is present is detected with the detection elements and based on the position of the detected check line within the one block in the main scanning direction, the moved position of the subsequent block is corrected.

### BRIEF DESCRIPTION OF THE DRAWINGS

FIG. 1 is a cross-sectional view showing a schematic configuration of an inkjet recording device to which a method of detecting a discharge abnormality in nozzles according to an embodiment of the present disclosure is applied;

FIG. 2 is a perspective view of the recording portion of the inkjet recording device in FIG. 1;

FIG. 3 is a plan view of the recording portion of the inkjet recording device in FIG. 1;

FIG. 4 is a block diagram showing a schematic configuration of a discharge abnormality detection device which is used in the method of detecting a discharge abnormality in the nozzles of the inkjet recording device according to the embodiment of the present disclosure;

FIG. 5 is a flowchart showing an example of nozzle check processing in a method of detecting a discharge abnormality in the nozzles of an inkjet recording device according to a first embodiment of the present disclosure;

FIG. 6 is a plan view showing an example of a check chart for detecting a discharge abnormality in the embodiment of the present disclosure;

FIG. 7 is an enlarged view of a main portion of the check chart in FIG. 6;

FIG. 8 is an illustrative view of a check pattern in the check chart of FIG. 7;

FIG. 9 is a flowchart showing an example of discharge abnormality detection processing in the method of detecting a discharge abnormality in the nozzles of the inkjet recording device according to the embodiment of the present disclosure;

FIG. 10 is an illustrative view of a discharge abnormality detection step in the embodiment of the present disclosure;

FIG. 11 is an illustrative view of a correction in a line detection step in the embodiment of the present disclosure;

FIG. 12 is an illustrative view of the correction in the line detection step in the embodiment of the present disclosure and is also a diagram showing a state where a foreign substance is present on the plane of the figure;

FIG. 13 is a flowchart showing an example of nozzle check processing in a method of detecting a discharge abnormality in the nozzles of an inkjet recording device according to a second embodiment of the present disclosure;

FIG. 14 is a cross-sectional view showing a schematic configuration of an inkjet recording device according to a third embodiment of the present disclosure; and

FIG. 15 is a block diagram showing a schematic configuration of the inkjet recording device in FIG. 14.

### DETAILED DESCRIPTION

Embodiments of the present disclosure will be described below with reference to drawings. The present disclosure is not limited to details which will be described below.

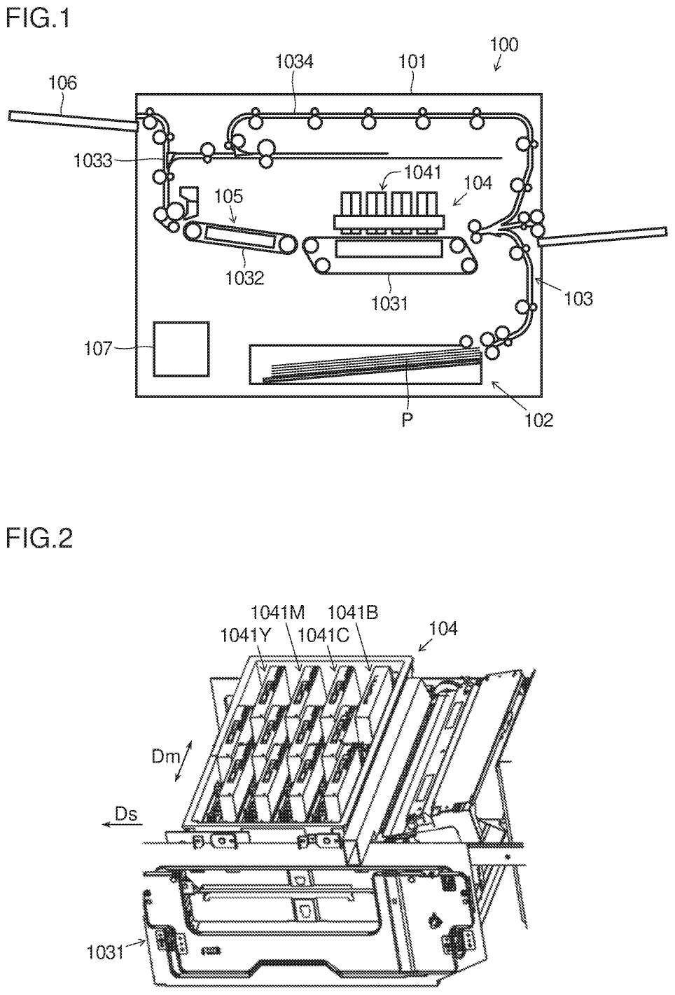

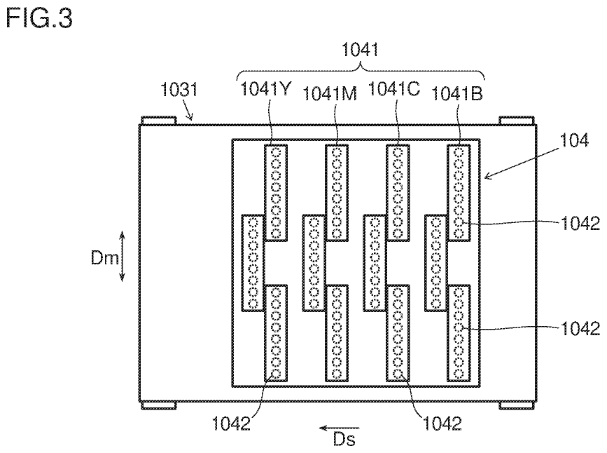

FIG. 1 is a cross-sectional view showing a schematic configuration of an inkjet recording device 100 to which a method of detecting a discharge abnormality in nozzles according to an embodiment is applied. FIG. 2 is a perspective view of the recording portion 104 of the inkjet recording device 100 in FIG. 1. FIG. 3 is a plan view of the recording portion 104 of the inkjet recording device 100 in FIG. 1. The inkjet recording device 100 is, for example, a printer of an inkjet recording type. As shown in FIGS. 1, 2 and 3, the inkjet recording device 100 includes a main body 101, a sheet supply portion 102, a sheet transport portion 103, the recording portion 104, a drying portion 105, a sheet ejection portion 106 and a printer control portion 107.

The sheet supply portion 102 stores a plurality of sheets (recording media) P, and separates and feeds out the sheets P one by one at the time of recording. The sheet transport portion 103 transports the sheet P fed out from the sheet supply portion 102 to the recording portion 104 and the drying portion 105, and further ejects the sheet P after recording and drying to the sheet ejection portion 106. The sheet transport portion 103 includes a first belt transport portion 1031 and a second belt transport portion 1032. The first belt transport portion 1031 and the second belt transport portion 1032 suck and hold the sheet P on the upper surface of an endless belt, and transport the sheet P. When double-sided recording is performed, the sheet transport portion 103 switches, with a branch portion 1033, the sheet P after the recording and drying of the first side to a reverse transport portion 1034, and further switches a transport direction so as to transport again, to the recording portion 104 and the drying portion 105, the sheet P in which the front and back sides are reversed.

The recording portion 104 is opposite the sheet P which is sucked and held on the upper surface of the first belt transport portion 1031 and which is transported, and is arranged above the first belt transport portion 1031 with a predetermined distance provided. The recording portion 104 includes a recording head 1041 of a line-type inkjet system. The recording head 1041 includes recording heads 1041B, 1041C, 1041M and 1041Y which respectively correspond to four colors of black, cyan, magenta and yellow. A plurality of (for example, three) recording heads 1041 of the individual colors are arranged in a staggered configuration along a sheet width direction (arrow Dm in FIG. 2=main scanning direction) orthogonal to a sheet transport direction (arrow Ds in FIG. 2=subscanning direction).

The recording head 1041 includes a plurality of ink discharge nozzles 1042 in an ink discharge portion which is a bottom portion thereof. The ink discharge nozzles 1042 are arranged to be aligned along the sheet width direction (main scanning direction) Dm, and thereby can discharge the inks over the entire recording region. The recording portion 104 sequentially discharges the inks from the recording heads 1041B, 1041C, 1041M and 1041Y of the four colors toward the sheet P which is transported with the first belt transport portion 103 so as to record a full-color image or a monochrome image on the sheet P.

The drying portion 105 is arranged on the downstream side of the recording portion 104 in the sheet transport direction, and the second belt transport portion 1032 is provided. While the sheet P on which the ink image is recorded in the recording portion 104 is sucked and held on the second belt transport portion 1032 and is transported in the drying portion 105, the inks are dried.

The printer control portion 107 includes a CPU and a storage portion which are not shown and an electronic circuit and electronic components which are not shown. The CPU controls, based on control programs and data stored in the storage portion, the operations of individual constituent elements provided in the inkjet recording device 100 so as to perform processing related to the functions of the inkjet recording device 100. The sheet supply portion 102, the sheet transport portion 103, the recording portion 104 and the drying portion 105 each individually receive commands from the printer control portion 107 so as to perform recording on the sheet P in a coordinated manner. The storage portion is formed with, for example, a combination of a nonvolatile storage device such as a program ROM (Read Only Memory) or a data ROM which is not shown and a volatile storage device such as a RAM (Random Access Memory).

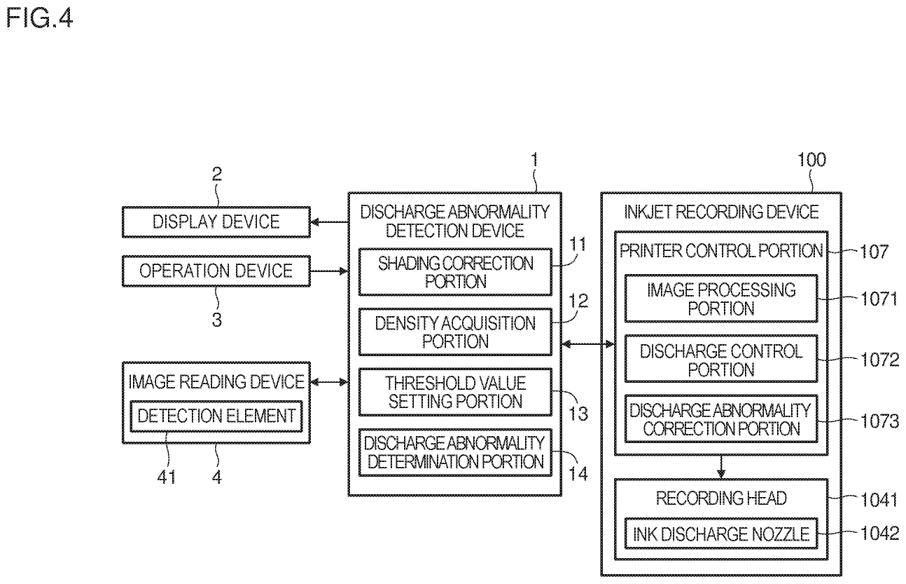

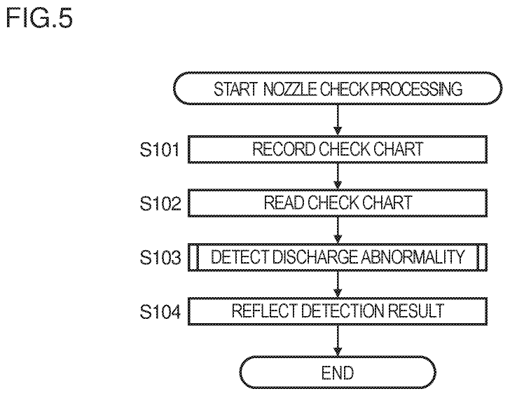

The configuration of a discharge abnormality detection device will then be described with reference to FIG. 4. FIG. 4 is a block diagram showing a schematic configuration of the discharge abnormality detection device 1 which is used in the method of detecting a discharge abnormality in the nozzles of the inkjet recording device 100 according to the embodiment.

The discharge abnormality detection device 1 is formed with, for example, a microcomputer, a personal computer or the like, and can perform various types of processing for detecting a discharge abnormality in the ink discharge nozzles 1042 of the inkjet recording device 100. The discharge abnormality detection device 1 is connected to a display device 2, an operation device 3 and an image reading device 4 which are shown in FIG. 4.

The display device 2 is formed with, for example, a liquid crystal display panel or the like, and can display various types of information on the discharge abnormality detection device 1, information on the results of the processing and the like. The operation device 3 is an input device which is formed with, for example, a keyboard, a touch panel and the like, and can input, to the discharge abnormality detection device 1, operation information, setting information and the like.

The image reading device 4 includes, for example, an image sensor such as a CCD (Charge Coupled Device) line sensor, optically reads the image of an original document, generates image data corresponding to the image and transmits it to the discharge abnormality detection device 1. The image sensor includes, for example, a plurality of detection elements 41, a light source, a lens and the like. The detection elements 41 are a plurality of photoelectric conversion elements, and substantially the same number of photoelectric conversion elements are aligned along the sheet width direction so as to correspond to the ink discharge nozzles 1042. The image reading device 4 receives, through the lens, with the detection elements 41, light which is applied from the light source toward the sheet P and which is then reflected off the sheet P, and thereby detects whether or not the inks discharged to the sheet P are present.

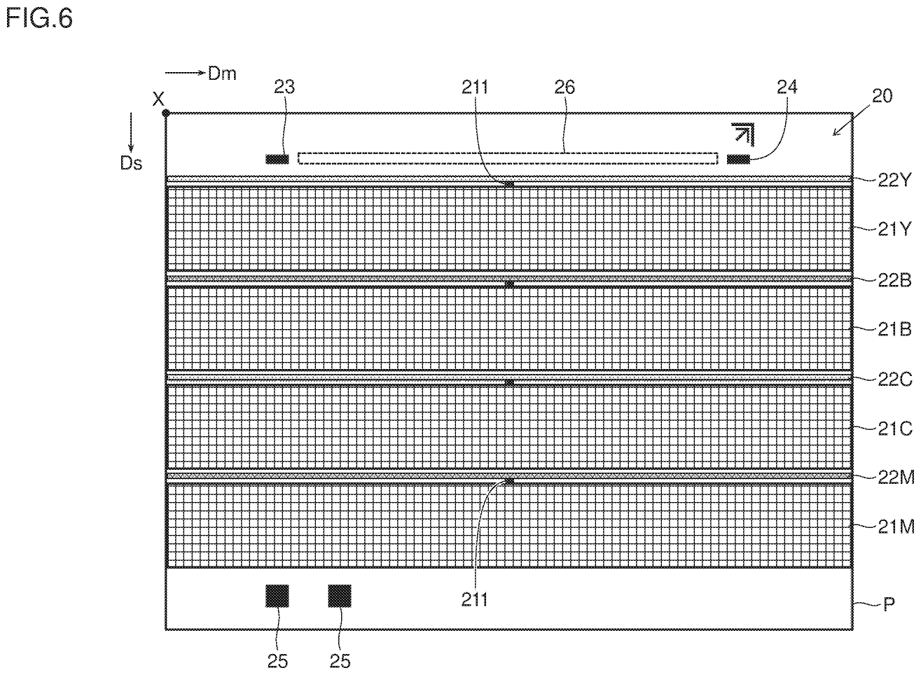

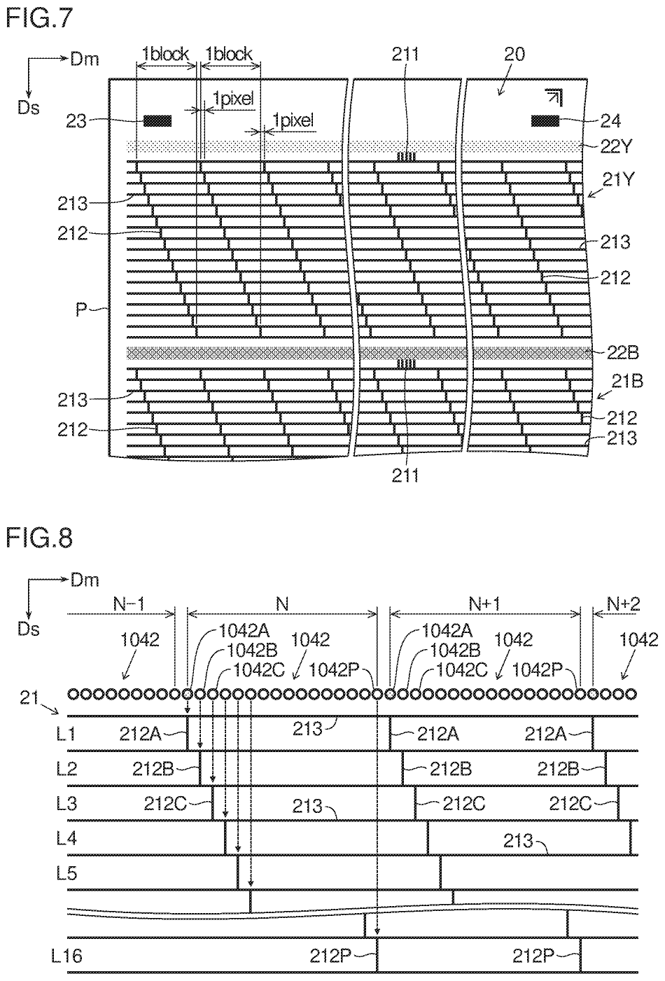

In the present embodiment, the image reading device 4 optically reads an image in a check chart 20 (see FIGS. 6 and 7) which is recorded on the original document and which will be described later, and thereby generates the image data of the check chart 20. The discharge abnormality detection device 1 performs, based on the image data of the check chart 20, various types of processing for detecting a discharge abnormality in the ink discharge nozzles 1042.

The discharge abnormality detection device 1 includes a shading correction portion 11, a density acquisition portion 12, a threshold value setting portion 13 and a discharge abnormality determination portion 14. The functions of these constituent elements included in the discharge abnormality detection device 1 are realized by performing computation processing according to predetermined programs.

The shading correction portion 11 performs shading correction on the image data acquired from the image reading device 4 according to the reading nonuniformity characteristic of the sheet in the main scanning direction with the image reading device 4, and thereby removes reading nonuniformity.

The density acquisition portion 12 acquires, based on the image data after being corrected with the shading correction portion 11, the density information of the sheet on which the check chart 20 is recorded.

The threshold value setting portion 13 sets, based on the density information acquired with the density acquisition portion 12, a threshold value for detecting a discharge abnormality in the ink discharge nozzles 1042.

The discharge abnormality determination portion 14 uses the threshold value set with the threshold value setting portion 13 so as to determine whether or not the check patterns 21 of the check chart 20 which are allocated to the individual ink discharge nozzles 1042 and which will be described later are drawn, and identifies an abnormal ink discharge nozzle 1042 from the result of the determination. The details of the functions of these constituent elements will be described later.

As described previously, the inkjet recording device 100 includes the printer control portion 107 which controls the recording operation using the ink discharge nozzles 1042. The printer control portion 107 includes an image processing portion 1071, a discharge control portion 1072 and a discharge abnormality correction portion 1073. The functions of these constituent elements included in the printer control portion 107 are realized by performing computation processing according to predetermined programs.

The image processing portion 1071 generates, based on the image data for recording input to the inkjet recording device 100, recording data for actual recording on the sheet P. The image processing portion 1071 also generates, when a discharge abnormality in the ink discharge nozzles 1042 is detected in the maintenance of the inkjet recording device 100, recording data for recording the check chart 20 on the sheet P.

The discharge control portion 1072 controls operations of discharging ink droplets with the individual ink discharge nozzles 1042 such that an image corresponding to the recording data generated with the image processing portion 1071 is recorded on the sheet P.

The discharge abnormality correction portion 1073 performs various types of correction processing when an abnormal ink discharge nozzle 1042 is identified in the discharge abnormality detection device 1. For example, when the discharge abnormality correction portion 1073 receives, from the discharge abnormality detection device 1, information indicating that one ink discharge nozzle 1042 is a non-discharge nozzle, the discharge abnormality correction portion 1073 performs correction on a pixel which needs to be drawn with the non-discharge nozzle such as by increasing the amounts of discharge of other ink discharge nozzles 1042 present around the non-discharge nozzle. The discharge abnormality correction portion 1073 uses a nozzle cleaning mechanism or a nozzle purge mechanism (both of which are not shown) included in the inkjet recording device 100 so as to perform a wiping operation for wiping nozzle discharge ports or a purge operation for discharging the ink or a cleaning liquid with a high pressure. The discharge abnormality correction portion 1073 provides an instruction to increase the number of times these correction operations are performed or the frequency at which these correction operations are performed.

FIG. 5 is a flowchart showing an example of nozzle check processing in the method of detecting a discharge abnormality in the nozzles of an inkjet recording device 100 according to a first embodiment. The nozzle check processing in the method of detecting a discharge abnormality in the nozzles of the inkjet recording device 100 will be described with reference to the processing flow of FIG. 5. The nozzle check processing is processing which is performed by a user in order to grasp whether or not an abnormality such as clogging occurs in the ink discharge nozzles 1042 during the use of the inkjet recording device 100.

When the nozzle check processing is started, in the inkjet recording device 100, a step of recording the image in the check chart 20 on the sheet P stored in the sheet supply portion 102 is performed (step S101). Specifically, the image data of the check chart 20 is transmitted to the image processing portion 1071 of the printer control portion 107, and thus the recording data of the image data is generated. The discharge control portion 1072 controls the recording head 1041 based on the recording data of the check chart 20 generated with the image processing portion 1071 so as to record the check chart 20 on the sheet P.

More specifically, in the chart recording step described above, a plurality of ink discharge nozzles 1042 which are arranged to be aligned along the main scanning direction Dm in the recording head 1041 are made to perform the operation of discharging the inks, and thus the check chart 20 including the check patterns 21 which are drawn with only the individual ink discharge nozzles 1042 and which will be described later is recorded on the sheet P. The image data of the check chart 20 is previously stored in the storage portion or the like within the inkjet recording device 100.

Then, the check chart 20 recorded on the sheet P is optically read with the image reading device 4 (step S102). Specifically, in the chart reading step described above, for example, with a plurality of detection elements 41 which are aligned along the main scanning direction so as to correspond the ink discharge nozzles 1042, the check chart 20 recorded on the sheet P is read. The image reading device 4 generates the image data corresponding to the image which is read so as to transmit the image data to the discharge abnormality detection device 1.

Then, the discharge abnormality detection device 1 performs, based on the image data of the check chart 20 received from the image reading device 4, discharge abnormality detection processing for determining an abnormality in the ink discharge nozzles 1042 (step S103). Specifically, in the discharge abnormality detection step described above, an abnormality in the ink discharge nozzles 1042 is determined by whether or not the check patterns 21 described later are drawn in the image data of the check chart 20 read from the sheet P. The details of the discharge abnormality detection processing of the ink discharge nozzles 1042 will be described later.

Then, the result of the detection of a discharge abnormality obtained in step S103 is reflected (step S104). For example, when an abnormal ink discharge nozzle 1042 is identified in the discharge abnormality detection device 1, the discharge abnormality correction portion 1073 of the inkjet recording device 100 performs various types of correction processing. In other words, the discharge abnormality correction portion 1073 performs, for example, on the non-discharge nozzle, the correction processing of the pixel, the wiping operation, the purge operation or the like which is previously described.

Then, the nozzle check processing is completed.

FIG. 6 is a plan view showing an example of the check chart 20 for detecting a discharge abnormality in the embodiment. In the following description related to the check chart 20, the upper left corner X of the check chart 20 shown in FIG. 6 is assumed to be an upstream end in the main scanning direction Dm and an upstream end in the subscanning direction Ds. Unless there is a need to provide a limitation, the identification symbols of “B”, “C”, “M” and “Y” which indicate the individual colors may be omitted.

The check chart 20 includes: check patterns 21Y, 21B, 21C and 21M which are drawn with only the ink droplets of the individual colors of yellow, black, cyan and magenta; solid patterns 22Y, 22B, 22C and 22M which are likewise drawn with the ink droplets of the individual colors; and a first reference patch 23, a second reference patch 24 and a pair of third reference patches 25 for identifying the positions of the patterns.

The check patterns 21Y, 21B, 21C and 21M each are patterns which have a net-shaped design drawn with thin lines, and are also strip-shaped patterns which have a predetermined length in the subscanning direction Ds and which are extended over the entire region in the main scanning direction Dm. FIG. 5 shows an example where the check patterns 21Y, 21B, 21C and 21M are arranged from the upstream side in the subscanning direction in the order of yellow (21Y), black (21B), cyan (21C) and magenta (21M). In each of the check patterns 21Y, 21B, 21C and 21M, a reference address pattern 211 is additionally provided which is drawn in a center position in the main scanning direction Dm.

The solid patterns 22Y, 22B, 22C and 22M each are patterns which are painted in solid colors with the ink droplets of the individual colors, and are also thin strip-shaped patterns which have a short width in the subscanning direction Ds and which are extended over the entire region in the main scanning direction Dm. FIG. 6 shows an example where the solid patterns 22Y, 22B, 22C and 22M of the individual colors are respectively drawn adjacent to the check patterns 21Y, 21B, 21C and 21M of the individual colors on the upstream side in the subscanning direction.

The first reference patch 23, the second reference patch 24 and the pair of third reference patches 25 are rectangular patterns which are formed by being painted in the solid color of black and which have small areas, and are arranged outside the entire drawing region of the check patterns 21Y, 21B, 21C and 21M and the solid patterns 22Y, 22B, 22C and 22M. The first reference patch 23 is arranged on the upstream side in the subscanning direction Ds with respect to the solid pattern 22Y and on the upstream side in the main scanning direction Dm with respect to the center. The second reference patch 24 is arranged in the same position in the subscanning direction Ds as the first reference patch 23 and on the downstream side in the main scanning direction Dm with respect to the center. The pair of the third reference patches 25 are arranged on the downstream side in the subscanning direction Ds with respect to the check pattern 21M, on the upstream side in the main scanning direction Dm with respect to the center and parallel to the main scanning direction Dm.

FIG. 7 is an enlarged view of a main portion of the check chart 20 in FIG. 6. Each of the check patterns 21Y, 21B, 21C and 21M includes check lines 212 which are short vertical lines (lines which are extended along the subscanning direction Ds) and boundary lines 213 which are long horizontal lines (lines which are extended along the main scanning direction Dm). Each of the check lines 212 of the individual colors is a thin line which is drawn with only a certain ink discharge nozzle 1042 among a plurality of ink discharge nozzles 1042 included in the recording head 1041. On the other hand, the solid patterns 22Y, 22B, 22C and 22M are patterns which are drawn with part or the whole of the ink discharge nozzles 1042 for discharging the ink droplets of the individual colors and which are painted in solid colors.

With respect to the check lines 212, among a plurality of pixels (ink discharge nozzles 1042) aligned along the main scanning direction Dm, a predetermined number of pixels in the main scanning direction Dm are set to one block, and the check lines 212 are drawn one by one in each of the blocks. FIG. 7 shows an example where the one block is formed with 16 pixels. With the first pixel (one ink discharge nozzle 1042) among the 16 pixels, the check line 212 is drawn in a predetermined position in the subscanning direction Ds. Then, the position is shifted a predetermined length to the downstream side in the subscanning direction Ds, and the check line 212 is drawn with the second pixel adjacent to the first pixel. In this way, the check lines 212 of 16 rows corresponding to the 16 pixels of one block are drawn while being gradually shifted to the downstream side in the subscanning direction Ds and the downstream side in the main scanning direction Dm.

In other words, in the check pattern 21, among a plurality of ink discharge nozzles 1042, a predetermined number (for example, 16) of ink discharge nozzles 1042 in the main scanning direction Dm are set to one block, and in each of the blocks, a plurality of check lines 212 each of which is recorded with one of the ink discharge nozzles 1042 and which are extended along the subscanning direction Ds are drawn such that each time the check lines 212 proceed a predetermined length in the subscanning direction Ds, the check lines 212 are sequentially shifted line by line in the main scanning direction Dm. The boundary lines 213 are lines which indicate boundaries between the check lines 212 of 16 rows.

FIG. 8 is an illustrative view of the check pattern 21 in the check chart 20 of FIG. 7. Here, the pixels described above are schematically shown by being replaced with the ink discharge nozzles 1042.

One block N is formed with 16 ink discharge nozzles 1042A, 1042B, 1042C, . . . and 1042P. The same is true for other blocks N+1 and N−1. When attention is focused on the block N, among the 16 ink discharge nozzles 1042A, 1042B, 1042C, . . . and 1042P, the discharge control portion 1072 makes the ink discharge nozzle 1042A located on the most upstream side in the main scanning direction Dm perform an operation of discharging the ink droplets. In this way, on the sheet, a check line 212A in the first row L1 on the most upstream side in the subscanning direction Ds is drawn a predetermined length along the subscanning direction Ds. Thereafter, on the lower side of the check line 212A in the first row L1, the boundary line 213 which is extended in the main scanning direction is drawn.

Then, with the ink discharge nozzle 1042B adjacent to the ink discharge nozzle 1042A on the downstream side in the main scanning direction Dm, a check line 212B in the second row L2 is drawn on the downstream side of the check line 212A in the subscanning direction Ds. By a difference between the positions of the ink discharge nozzle 1042A and the ink discharge nozzle 1042B, the check line 212B in the second row L2 is drawn in a position which is shifted in the main scanning direction Dm and the subscanning direction Ds with respect to the check line 212A in the first row L1.

Furthermore, with the ink discharge nozzle 1042C adjacent to the ink discharge nozzle 1042B on the downstream side in the main scanning direction Dm, a check line 212C in the third row L3 is drawn on the downstream side of the check line 212B in the subscanning direction Ds. The check line 212C in the third row L3 is also drawn in a position which is shifted in the main scanning direction Dm and the subscanning direction Ds with respect to the check line 212B in the second row L2. Likewise, the check lines 212 are sequentially drawn until the sixteenth row L16.

In other words, the check lines 212A, 212B, 212C, . . . and 212P which are respectively drawn with the ink discharge nozzles 1042A, 1042B, 1042C, . . . and 1042P individually have unique addresses in the main scanning direction Dm and the subscanning direction Ds. These addresses can be converted into coordinates with the first reference patch 23, the second reference patch 24 and the pair of third reference patches 25 used as reference positions. Then, the density values of the sheet P in coordinate positions in which the check lines 212A, 212B, 212C, . . . and 212P need to be drawn are acquired, and thus it is possible to determine whether or not a discharge abnormality is present in the ink discharge nozzles 1042A, 1042B, 1042C, . . . and 1042P.

For example, when the ink discharge nozzle 1042B is clogged, the check line 212B in the second row L2 is not properly drawn so as to be prevented from being recorded on the sheet P. Hence, in the image data obtained by reading the sheet P with the image reading device 4, the density value of coordinates where the check line 212B needs to be present is a density value which indicates the ground color of the sheet P. Hence, it is possible to grasp that the ink discharge nozzle 1042B is a non-discharge nozzle. When the check line 212B is properly drawn, the density value of the coordinates indicates a value higher than the density value indicating the ground color of the sheet P.

However, depending on the type of sheet P which is used in the detection of a discharge abnormality in the ink discharge nozzles 1042, it is likely that the check pattern 21 cannot be detected with high accuracy. For example, when a sheet whose quality is poor, recycled paper, groundwood paper or the back side of a printed sheet (so-called backing paper) is used, it is likely that whether or not the check lines 212 in the check pattern 21 are properly recorded cannot be appropriately determined.

Specifically, a difference in density between the ground color of the sheet P whose whiteness is low and the color of the check pattern 21 is decreased, and thus when a previously fixed density threshold value is used, it is likely that it is impossible to accurately distinguish both of them. The recording of the check chart 20 on the sheet P is generally performed by the user. Depending on the user, it is likely that the use of high-quality paper is avoided in the detection of a discharge abnormality in the ink discharge nozzles 1042, and thus the accuracy of detection of a discharge abnormality may be lowered. In the present embodiment, in order to solve such a problem, a method of detecting a discharge abnormality in the nozzles of the inkjet recording device 100 is provided so as to be able to detect an abnormality in the ink discharge nozzles 1042 with high accuracy.

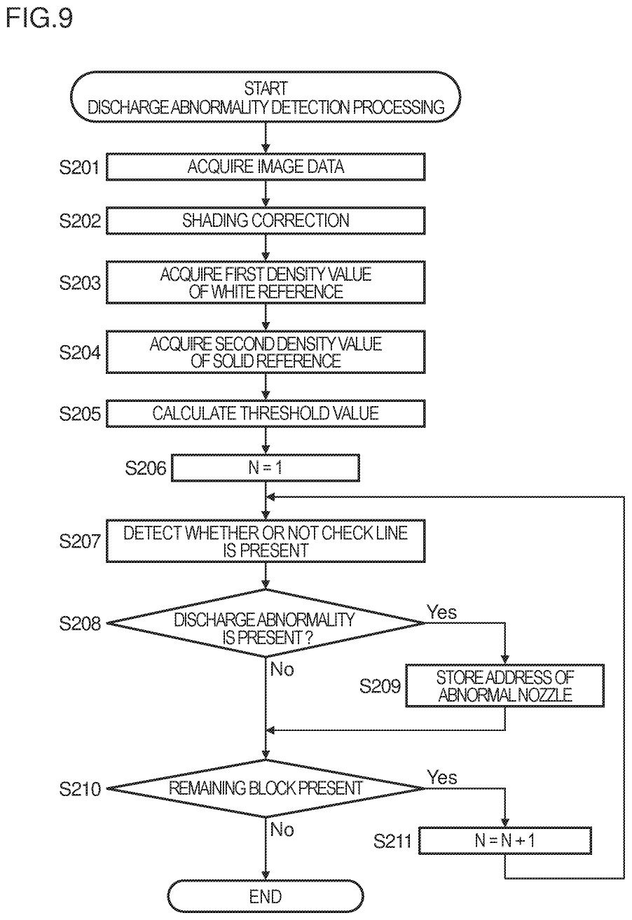

FIG. 9 is a flowchart showing an example of the discharge abnormality detection processing in the method of detecting a discharge abnormality in the nozzles of the inkjet recording device 100 according to the embodiment. FIG. 9 shows the details of step S103 in the flow of the nozzle check processing of FIG. 5. Hence, before the discharge abnormality detection processing, the check chart 20 illustrated in FIG. 6 is recorded with the inkjet recording device 100 on the sheet P and is read with the image reading device 4 so as to be converted into the image data (steps S101 an S102 in FIG. 5).

When the discharge abnormality detection processing is started, the discharge abnormality detection device 1 acquires the image data of the check chart 20 which is read with the image reading device 4 (step S201).

Then, the shading correction portion 11 of the discharge abnormality detection device 1 performs the shading correction on the image data of the check chart 20 so as to remove reading nonuniformity in the image reading device 4. (step S202).

Before the check chart 20 is actually read with the image reading device 4, the reading nonuniformity in the image reading device 4 is detected. Specifically, the image reading device 4 is made to read a reading nonuniformity detection chart, and a reading nonuniformity characteristic in the main scanning direction Dm caused by an error in an optical system and characteristic nonuniformity is derived. Information related to the reading nonuniformity characteristic is previously stored in a storage portion or the like within the discharge abnormality detection device 1. The shading correction portion 11 references the reading nonuniformity characteristic, and corrects the image data acquired in step S201 so as to remove the reading nonuniformity.

Then, the density acquisition portion 12 detects the part of the ground color of the sheet P in the image data on which the shading correction is performed, and acquires a first density value indicating the density value of the ground color of the sheet P (step S203). Since the first density value is the density value of the part of the sheet P on which recording processing is not performed, the first density value is a density value indicating a white reference in the sheet P.

As shown in FIG. 6, the check chart 20 is recorded not on the entire region of the sheet P but on part of the sheet P. Hence, in the sheet P, part is present through which the ground color is exposed as it is. For example, in FIG. 6, on the upstream side in the subscanning direction Ds with respect to the solid pattern 22Y of yellow and on the downstream side in the subscanning direction Ds with respect to the check pattern 21M, the parts of the ground color of the sheet P are present. On the upstream side in the subscanning direction Ds with respect to the solid pattern 22Y of yellow, a ground color reading region 26 for reading the density of the ground color of the sheet P is provided.

In order to detect the ground color reading region 26, the density acquisition portion 12 utilizes the position information of the first reference patch 23 and the second reference patch 24. For example, based on a distance (the number of pixels) from the downstream end edge of the first reference patch 23 in the main scanning direction Dm and a distance from the upstream end edge of the second reference patch 24 in the main scanning direction Dm, the position of the ground color reading region 26 is identified. In other words, the ground color reading region 26 is provided in a position (position between the patches) which can be easily identified by utilization of the first reference patch 23 and the second reference patch 24.

With respect to the density value of the ground color of the sheet P, for example, the density acquisition portion 12 acquires, as the first density value, an average value calculated with density values which are detected in a plurality of parts within the ground color reading region 26. For example, the density acquisition portion 12 sets the ground color reading region 26 as a range of 4750 pixels in the main scanning direction Dm and 10 pixels in the subscanning direction Ds between the first reference patch 23 and the second reference patch 24, and an average value calculated with the density values of these pixels is determined as the first density value of the white reference. In this way, the reliable density value of the ground color of the sheet P can be acquired.

Then, the density acquisition portion 12 detects, in the image data on which the shading correction is performed, the recording parts of the solid patterns 22Y, 22B, 22C and 22M in the sheet P, and acquires a second density value indicating the density values of the solid patterns 22Y, 22B, 22C and 22M (step S204). Since the second density value is the density value of the patterns which are drawn with the ink droplets of the individual colors on the sheet P and which are painted in solid colors, the second density value is a density value indicating a solid reference in the sheet P.

A solid reading region for acquiring the second density value of the solid reference is provided within each of the solid patterns 22Y, 22B, 22C and 22M. As in the case of the detection of the ground color reading region 26, in order to detect the solid reading region, for example, the density acquisition portion 12 utilizes the position information of the first reference patch 23 and the second reference patch 24 so as to identify the position of the solid reading region.

With respect to the density values of the individual solid patterns 22Y, 22B, 22C and 22M, for example, the density acquisition portion 12 acquires, as the second density value, an average value calculated with density values which are detected in a plurality of parts within the solid reading region. For example, the density acquisition portion 12 sets the solid reading region as a range of 5000 pixels in the main scanning direction Dm and 10 pixels in the subscanning direction Ds within the solid patterns 22, and an average value calculated with the density values of these pixels is determined as the second density value of the solid reference. The density acquisition portion 12 calculates the second density value for each of the colors of RGB.

Then, the threshold value setting portion 13 performs processing which uses the first density value of the white reference and the second density value of the solid reference acquired with the density acquisition portion 12 so as to calculate the threshold value for detecting a discharge abnormality in the ink discharge nozzles 1042 (step S205). In other words, in the present embodiment, in order to detect a discharge abnormality, a fixed threshold value which is previously stored in the storage portion or the like is not used. In the present embodiment, the first density value (the white reference) which is the density value of the ground color of the sheet P used in the recording of the check chart 20 and the second density value (the solid reference) which is the density value of the inks painted in solid colors on the sheet P are used, and thus the threshold value is calculated. The threshold value is calculated for each of the colors of yellow, black, cyan and magenta.

For example, this threshold value is a value that is calculated with a predetermined formula previously stored in the storage portion or the like and that corresponds to a density which is higher than the density indicated by the first density value of the white reference but is lower than the density indicated by the second density value of the solid reference, and is also a value that corresponds to such a density that the part of the ground color of the sheet P is prevented from being erroneously determined to be the check line 212 and that the check line 212 is prevented from being erroneously determined to be the part of the ground color of the sheet P. This threshold value is a local threshold value on the sheet P used in the recording of the check chart 20, and is also a threshold value on which the aspect of the sheet P is reflected.

Then, the discharge abnormality determination portion 14 sets a counter for a block number N which is allocated to each of determination blocks including one check line 212 such that N=1 (step S206).

Then, the discharge abnormality determination portion 14 detects whether or not the check line is present in the Nth determination block (step S207). Specifically, the discharge abnormality determination portion 14 compares the threshold value calculated in step S205 with a density value detected in the Nth determination block.

Then, the discharge abnormality determination portion 14 determines whether or not the check line 212 is drawn in the Nth determination block, that is, whether or not a discharge abnormality is present in the ink discharge nozzle 1042 which needs to draw the check line 212 in the determination block (step S208). Specifically, the discharge abnormality determination portion 14 determines whether or not the density value of the Nth determination block exceeds the threshold value.

For example, when the check line 212 is properly drawn in the determination block, the density value of the determination block is higher than the threshold value. In this case, the ink discharge nozzle 1042 is determined to be “proper”. For example, when the check line 212 is not properly drawn in the determination block, the density value of the determination block is lower than the threshold value. In this case, the ink discharge nozzle 1042 is determined to be “abnormal”.

When the ink discharge nozzle 1042 is determined to be “abnormal” (yes in step S208), the discharge abnormality determination portion 14 stores an identifier such as an address allocated to the ink discharge nozzle 1042 in the unillustrated storage portion or the like within the discharge abnormality detection device 1 (step S209).

When the ink discharge nozzle 1042 is determined to be “proper” (no in step S208) or after the address of the abnormal nozzle is stored in step S209, the discharge abnormality determination portion 14 determines whether or not a block on which the determination of a discharge abnormality needs to be performed is left (step S210).

When a block on which the determination of a discharge abnormality needs to be performed is left (yes in step S210), the discharge abnormality determination portion 14 sets the counter for the block number N which is allocated to each of determination blocks including one check line 212 such that N=N+1 (step S211). Then, the process is returned to step S207, and the discharge abnormality determination portion 14 compares the threshold value described above with a density value which is detected in the (N+1)th determination block so as to further determine whether or not a discharge abnormality is present in the ink discharge nozzle 1042 of the (N+1)th determination block.

When a block on which the determination of a discharge abnormality needs to be performed is not left (no in step S210), the flow of the discharge abnormality detection processing is completed.

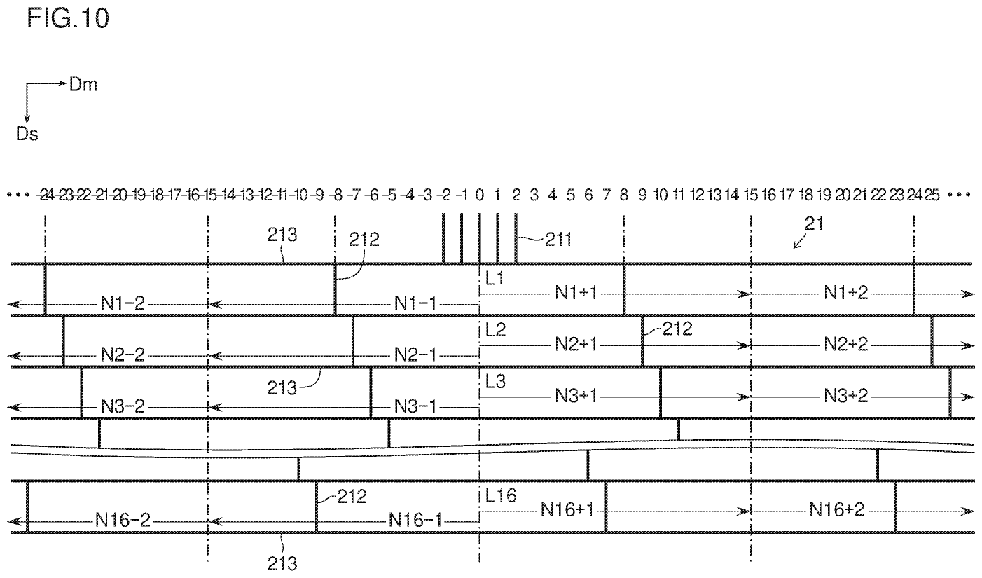

FIG. 10 is an illustrative view of the discharge abnormality detection step in the embodiment. In each of the check patterns 21 of the individual colors, the reference address pattern 211 is additionally provided which is drawn in the center position in the main scanning direction Dm. The reference address pattern 211 is formed with five straight lines which are drawn with five pixels (ink discharge nozzles 1042) and which are extended in the subscanning direction Ds.

In the discharge abnormality detection step of the ink discharge nozzles 1042, the density values are detected in each of the blocks which is formed with a pixel group of 16 pixels on the downstream side and the upstream side in the main scanning direction Dm with reference to the center (reference address=0) of the reference address pattern 211.

For example, in the first row L1 in the subscanning direction Ds, in each of the first block N1+1 on the downstream side and the first block N1−1 on the upstream side in the main scanning direction Dm, the density values of the individual pixels are checked, and whether or not a pixel whose density value exceeds the threshold value is present, that is, whether or not the check line 212 is properly drawn is detected. The ink discharge nozzles 1042 corresponding to the reference address ±8th are determined to be “proper” when a pixel whose density value exceeds the threshold value is detected whereas the ink discharge nozzles 1042 are determined to be “abnormal” when a pixel whose density value exceeds the threshold value is not detected.

In other words, the discharge abnormality detection step includes a line detection step of detecting, by one block, whether or not the check line 212 in the check pattern 21 is present by whether or not the densities of the pixels detected with the detection elements 41 are density values which exceed the predetermined threshold value. When the check line 212 is not properly drawn, the density values of the pixels corresponding to the ink discharge nozzles 1042 described above are lower than the threshold value so as to be determined to be “abnormal”. In the present embodiment the ink discharge nozzles 1042 described above are determined to be “non-discharge nozzles”.

Then, the detection range is moved by one block in the main scanning direction Dm. In blocks N1+2 and N1−2 respectively adjacent to the blocks N1+1 and N1−1 on the downstream side and the upstream side in the main scanning direction Dm, the density values of the individual pixels are likewise checked, and whether or not a pixel whose density value exceeds the threshold value is present, that is, whether or not the check line 212 is properly drawn is detected. Then, in the line detection step of detecting whether or not the check line 212 is present, whether the ink discharge nozzles 1042 are determined to be “proper” or “abnormal (non-discharge)”.

Then, on the remaining blocks present in the first row L1 in the subscanning direction Ds, the detection of a discharge abnormality in the ink discharge nozzles 1042 is performed. Furthermore, in the step of detecting a discharge abnormality in the ink discharge nozzles 1042, when the detection is completed in the first row L1 in the subscanning direction Ds, the detection proceeds to the second row L2, and when the detection is completed in the second row L2, the detection proceeds to the third row L3. Thereafter, likewise, until the sixteenth line L16, the detection of a discharge abnormality in the ink discharge nozzles 1042 is performed.

Then, in order to detect an abnormal ink discharge nozzle 1042 with higher accuracy, in the line detection step of the present embodiment, when the detection range is sequentially moved by one block in the main scanning direction Dm, a moved position is corrected.

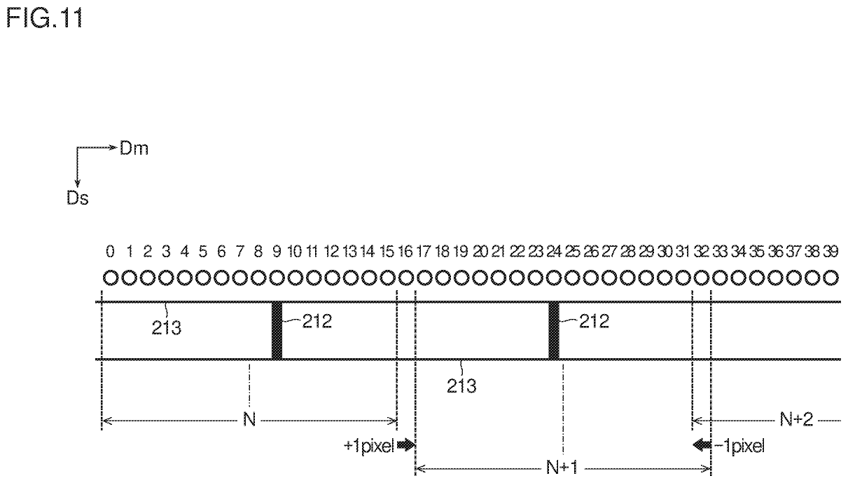

FIG. 11 is an illustrative view of the correction in the line detection step of the embodiment. In an example shown in FIG. 11, a block N formed with 16 pixels in the main scanning direction Dm has the check line 212 in the position of the 9th address. In other words, the block N has the check line 212 on the downstream side with respect to a center portion within one block in the main scanning direction Dm. In this case, the discharge abnormality determination portion 14 performs a correction such that when the detection range is subsequently moved by one block in the main scanning direction Dm, one pixel is added on the downstream side in the main scanning direction Dm to the moved position. In other words, the block N+1 which is the subsequent detection range is formed with 16 pixels from the 17th address to the 32nd address.

Then, the block N+1 has the check line 212 in the position of the 24th address. In other words, the block N+1 has the check line 212 on the upstream side with respect to the center portion within the one block in the main scanning direction Dm. In this case, the discharge abnormality determination portion 14 performs a correction such that when the detection range is subsequently moved by one block in the main scanning direction Dm, one pixel is reduced on the upstream side in the main scanning direction Dm from the moved position. In other words, the block N+2 which is the subsequent detection range is formed with 16 pixels starting from the 32nd address.

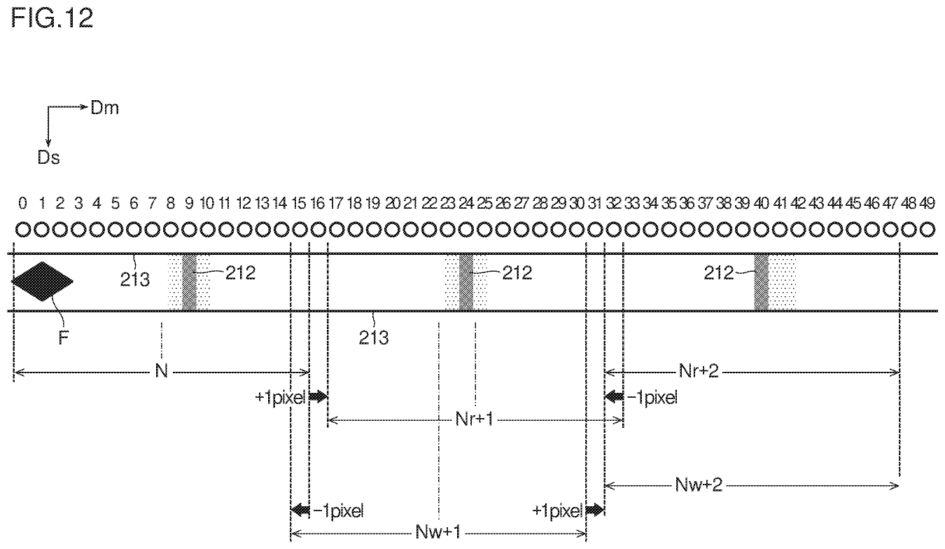

FIG. 12 is an illustrative view of the correction in the line detection step of the embodiment and is also a diagram showing a state where a foreign substance F is present on the plane of the figure. In an example shown in FIG. 12, a block N formed with 16 pixels in the main scanning direction Dm has the check line 212 in the position of the 9th address. The block N further has the foreign substance F around the 1st address. The foreign substance F is, for example, dust or dirt which is adhered to the surface of the sheet P, a fiber which is included within the sheet P and whose color is different from the surrounding or the like.

Here, for example, when it is considered that the foreign substance F is not present in the block N, since the block N has the check line 212 on the downstream side (the 9th address) with respect to the center portion in the main scanning direction Dm, one pixel is added on the downstream side to a block Nr+1 which is the subsequent detection range, with the result that the block Nr+1 is formed with 16 pixels from the 17th address to the 32nd address. Furthermore, since the block Nr+1 has the check line 212 on the upstream side (the 24th address) with respect to the center portion in the main scanning direction Dm, one pixel is reduced on the upstream side from a block Nr+2 which is the subsequent detection range, with the result that the block Nr+2 is formed with 16 pixels from the 32nd address to the 47th address.

On the other hand, when the foreign substance F is present in the block N, the discharge abnormality determination portion 14 recognizes, in addition to the check line 212 in the 9th address, as the check line, the foreign substance F around the 1st address. In this case, the discharge abnormality determination portion 14 may perform a correction such that when the detection range is subsequently moved by one block in the main scanning direction Dm, one pixel is reduced on the upstream side in the main scanning direction Dm from the moved position. In other words, a block Nw+1 which is the subsequent detection range is formed with 16 pixels from the 15th address to the 30th address.

Furthermore, since the block Nw+1 has the check line 212 on the downstream side (the 24th address) with respect to the center portion in the main scanning direction Dm, one pixel is added on the downstream side to a block Nw+2 which is the subsequent detection range, with the result that the block Nw+2 is formed with 16 pixels from the 32nd address to the 47th address.

In other words, when the foreign substance F is not present in the block N or even when the foreign substance F is present in the block N, the blocks Nr+2 and Nw+2 which are the detection ranges two rounds ahead of the present detection range are formed with 16 pixels in the same addresses. That is, a problem is prevented in which the detection range after being moved is significantly displaced due to the presence of the foreign substance F in the block N and in which thus the check line 212 is lost.

As described above, in the method of detecting a discharge abnormality in the nozzles of the inkjet recording device 100, in the line detection step of the embodiment, the detection range is sequentially moved by one block in the main scanning direction Dm, whether or not the check line 212 is present is detected with the detection elements 41 and based on the position of the detected check line 212 within the one block in the main scanning direction Dm, the moved position of the subsequent block is corrected.

In this configuration, even when dust, dirt or the like present on the sheet P is detected as the check line 212, based on the position of the proper check line 212 within the one block of the subsequent movement destination, the moved position is corrected in the further subsequent block. In this way, it is possible to detect the position (discharge position) of the check line 212 without any error. Hence, even when any type of sheet P is used in the recording of the check chart 20 for detecting a discharge abnormality, it is possible to detect an abnormal ink discharge nozzle 1042 with high accuracy.

When unlike the configuration of the embodiment described above, the detection range is simply sequentially moved by one block along the main scanning direction Dm, the position of the check line 212 is moved within the block in the main scanning direction Dm by an equal magnification displacement between a plurality of ink discharge nozzles 1042 in the inkjet recording device 100 and a plurality of detection elements 41 in the image reading device 4. In this way, there is a concern that even when the check line 212 is properly drawn, it is likely that the check line 212 cannot be appropriately detected.

However, in the line detection step of the present embodiment, the moved position of the subsequent block of the detection range is corrected, and thus the position (discharge position) of the check line 212 can be detected without any error even when the equal magnification displacement is produced, with the result that it is possible to detect an abnormal ink discharge nozzle 1042 with high accuracy.

Furthermore, in the method of detecting a discharge abnormality in the nozzles described above, when the position of the check line which is detected with the detection elements 41 is on the upstream side in a detection movement direction with respect to the center portion within the one block in the main scanning direction Dm, the moved position of the subsequent block is corrected to be on the upstream side whereas when the position of the check line is on the downstream side in the detection movement direction, the moved position of the subsequent block is corrected to be on the downstream side. In this configuration, the check line 212 within the one block which is the detection range can be constantly present substantially in the center portion in the main scanning direction Dm. In this way, it is possible to enhance the accuracy of the detection of the check line 212.

Preferably, in the method of detecting a discharge abnormality in the nozzles described above, based on an average value calculated with the positions of the check lines 212 detected with the detection elements 41 within the blocks which have been most recently moved a plurality of times, the moved position of the subsequent block is corrected. For example, when among the most recent five positions of the check lines 212, the three positions of the check lines 212 are on the upstream side in the detection movement direction with respect to the center portion within one block in the main scanning direction Dm, and the two positions of the check lines 212 are on the downstream side, the average value of the positions of the check lines 212 is on the upstream side in the movement direction. Hence, the moved position of the subsequent block is corrected to be on the upstream side in the movement direction. The correction of the subsequent moved position based on this average value is performed regardless of whether or not the foreign substance F is present. In this way, even when a large foreign substance F is present, it is possible to detect an abnormal ink discharge nozzle 1042 with high accuracy.

Here, it is assumed that a detected position when the check line 212 is detected in a position which is located one pixel on the downstream side in the detection movement direction with respect to the center portion within one block in the main scanning direction Dm is indicated by +1, and that a detected position when the check line 212 is detected in a position which is located one pixel on the upstream side in the detection movement direction is indicated by −1. In the example described above, the three detected positions are −1, and the two detected positions are +1, and thus the average value of the detected positions is −0.2.

In the correction described above, when the average value of the detected positions is 0, the correction of the movement value is 0, when the average value of the detected positions is negative, the correction of the movement value is −1, that is, 1 on the upstream side and when the average value of the detected positions is positive, the correction of the movement value is +1, that is, 1 on the downstream side. When the absolute value of the average value of the detected positions is large, the absolute value of the amended amount of the moved position may be increased accordingly. In other words, the direction of the correction of the moved position may be determined by whether the average value of the detected positions is positive or negative, and the magnitude of the correction of the moved position may be determined by rounding down the absolute value of the average value of the detected positions.

In another correction, the direction of the correction of the moved position may be determined by whether the average value of the detected positions is positive or negative, and the magnitude of the correction of the moved position may be determined by rounding off the absolute value of the average value of the detected positions.

In the method of detecting a discharge abnormality in the nozzles described above, when the subsequent moved position of the detection range is corrected, in which one of the region on the upstream side and the region on the downstream side the check line 212 is present with respect to the center portion within the one block in the main scanning direction Dm is identified. However, the region where the check line 212 is present may be identified by another method of partition.

For example, the one block may be partitioned into three regions of an upstream portion, a center portion and a downstream portion in the main scanning direction Dm. A configuration may be adopted in which when the position of the check line 212 which is detected with the detection elements 41 is in the center portion, the moved position of the subsequent block is not corrected. In this configuration, it is possible to reduce the complication of control related to the performance of the discharge abnormality detection step.

When a plurality of pixels whose density values exceed the threshold value are present within one block, for example, the position of the check line 212 is determined to be the position of a pixel in the center in the main scanning direction Dm among the pixels whose density values exceed the threshold value. In this configuration, it is possible to enhance the accuracy of the detection of the check line 212.

When a plurality of pixels whose density values exceed the threshold value are present within one block, for example, the position of a pixel whose density value is the highest and whose color is deep may be the position of the check line 212, and the position of a pixel which is closest to the center of the one block in the main scanning direction Dm and whose density value exceeds the threshold value may be the position of the check line 212.

When the number of pixels whose density values exceed the threshold value within one block is equal to or more than a predetermined number, the discharge abnormality determination portion 14 determines that a foreign substance is present. Furthermore, in the method of detecting a discharge abnormality in the nozzles described above, when a certain number or more of pixels whose densities exceed the threshold value are detected within one block, the check chart 20 is recorded again. In this case, the discharge abnormality detection device 1 uses, for example, the display device 2 so as to prompt the user to record the check chart 20 on the sheet P again. In this configuration, it is possible to significantly reduce the erroneous detection of the check line 212 caused by the presence of a foreign substance. Furthermore, it is preferable to prompt the user to change the type of sheet.

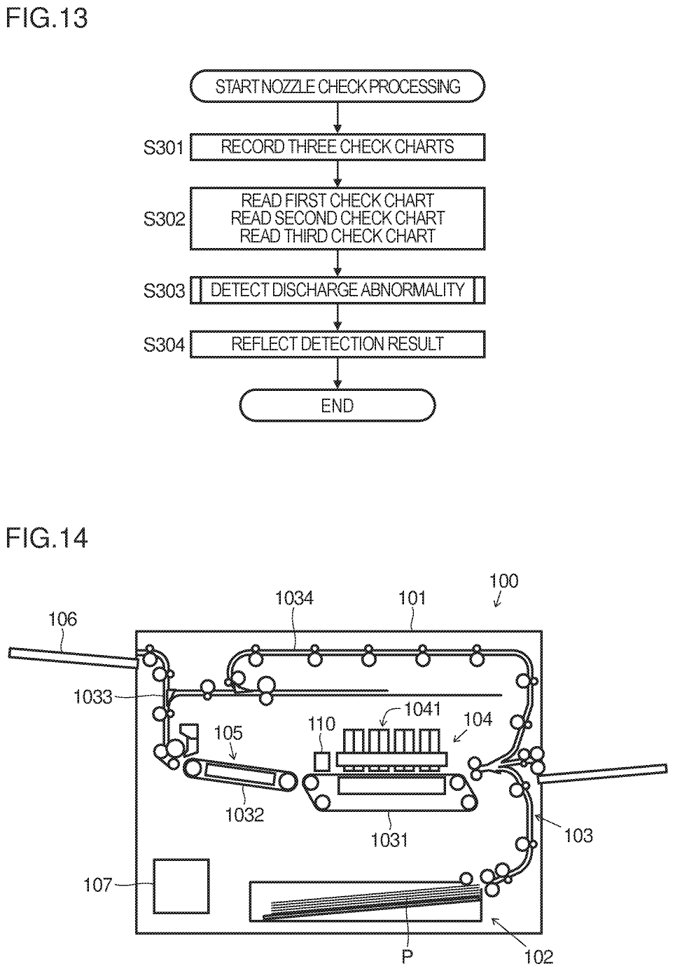

FIG. 13 is a flowchart showing an example of nozzle check processing in a method of detecting a discharge abnormality in the nozzles of an inkjet recording device 100 according to a second embodiment. Since the basic configuration of the second embodiment is the same as in the first embodiment described above, the same constituent elements and steps are identified with the same symbols and names as in the first embodiment, the description thereof may be omitted and the description of the configuration of parts other than a characteristic part will be omitted.

In the nozzle check processing in the method of detecting a discharge abnormality in the nozzles of the inkjet recording device 100 according to the second embodiment, in a chart recording step, the check charts 20 which include the check patterns 21 are individually recorded on a plurality of sheets P (for example, three sheets) (step S301). Furthermore, in a chart reading step, the check charts 20 on the three sheets P are read sequentially and individually (step S302).

Furthermore, a discharge abnormality detection step (step S303) is individually performed on the check charts 20 on the three sheets P. Then, when an abnormality is detected in the same pixels in the check charts 20 on the three sheets P, it is determined that the ink discharge nozzle 1042 corresponding to the pixel is abnormal. In this configuration, it is possible to reduce the erroneous detection of the check line 212 caused by the presence of a foreign substance with higher accuracy. When an abnormality is detected and an abnormality is not detected in the same pixels in the check charts 20 on the three sheets P, it is not determined that the ink discharge nozzle 1042 corresponding to the pixel is abnormal.

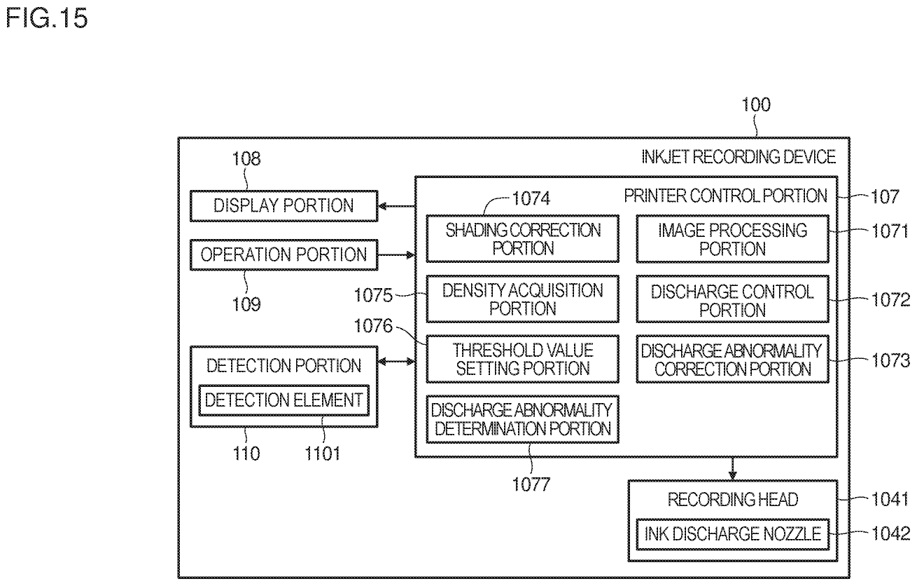

FIG. 14 is a cross-sectional view showing a schematic configuration of an inkjet recording device 100 according to a third embodiment. FIG. 15 is a block diagram showing a schematic configuration of the inkjet recording device 100 in FIG. 14. Since the basic configuration of the third embodiment is the same as in the first embodiment described above, the same constituent elements and steps are identified with the same symbols and names as in the first embodiment, the description thereof may be omitted and the description of the configuration of parts other than a characteristic part will be omitted.

The inkjet recording device 100 of the third embodiment includes, as shown in FIGS. 14 and 15, a main body 101, a sheet supply portion 102, a sheet transport portion 103, a recording portion 104, a drying portion 105, a sheet ejection portion 106, a printer control portion 107, a display portion 108, an operation portion 109 and a detection portion 110.

The display portion 108 is formed with, for example, a liquid crystal display panel or the like, is arranged on the outer surface of the main body 101 and can display various types of information on the inkjet recording device 100, information on the result of processing and the like. The operation portion 109 is, for example, an input portion formed with a touch panel or the like, is arranged on the outer surface of the main body 101 and can input operation information, setting information and the like to the inkjet recording device 100.

The detection portion 110 is formed with, for example, a contact image sensor, and includes a plurality of detection elements 1101, a light source, a lens and the like. The detection elements 1101 are a plurality of photoelectric conversion elements, and substantially the same number of photoelectric conversion elements are aligned along the sheet width direction (main scanning direction) so as to correspond to the ink discharge nozzles 1042. The detection elements 1101 are arranged opposite the sheet P which is transported with a sheet transport portion 103. The detection portion 110 receives, through the lens, with the detection elements 1101, light which is applied from the light source toward the sheet P and which is then reflected off the sheet P, and thereby detects whether or not the inks discharged to the sheet P are present. By utilization of the contact image sensor, it is possible to decrease the occupied space of the detection portion 110, and thus it is possible to reduce the size of the inkjet recording device 100. It is also possible to reduce the occurrence of optical distortion on the result of the detection, and thus the accuracy of the detection is enhanced.

The printer control portion 107 includes an image processing portion 1071, a discharge control portion 1072, a discharge abnormality correction portion 1073, a shading correction portion 1074, a density acquisition portion 1075, a threshold value setting portion 1076 and a discharge abnormality determination portion 1077. The functions of these constituent elements included in the printer control portion 107 are realized by performing computation processing according to predetermined programs.

The inkjet recording device 100 of the third embodiment performs the nozzle check processing in the method of detecting a discharge abnormality in the nozzles shown in FIG. 5. The printer control portion 107 controls a recording head 1041 so as to record the check chart 20 on the sheet P (step S101 in FIG. 5), and then makes the detection portion 110 read the check chart 20 recorded on the sheet P (step S102).

Specifically, the printer control portion 107 makes a plurality of ink discharge nozzles 1042 perform an operation of discharging inks so as to record, on the sheet P, the check chart 20 including the check patterns 21 drawn with only the individual ink discharge nozzles 1042, and makes the detection elements 1101 read the check chart 20. More specifically, in the printer control portion 107, among the ink discharge nozzles 1042, a predetermined number of ink discharge nozzles in the main scanning direction are set to one block, and in each of the blocks, a plurality of check lines 212 each of which is recorded with one of the ink discharge nozzles 1042 and which are extended along the subscanning direction Ds are drawn such that each time the check lines 212 proceed a predetermined length in the subscanning direction, the check lines 212 are sequentially shifted line by line in the main scanning direction, and the check chart 20 including the check patterns 21 where the check lines 212 are drawn is recorded on the sheet P.

The printer control portion 107 generates image data corresponding to the image which is read, and performs, based on the image data of the check chart 20, discharge abnormality detection processing for determining an abnormality in the ink discharge nozzles 1042 (step S103). The discharge abnormality detection processing is performed based on the processing flow shown in FIG. 9, and an abnormality in the ink discharge nozzles 1042 is determined by whether or not the check patterns 21 are drawn on the sheet P. Then, the result of the detection of a discharge abnormality is reflected (step S104 in FIG. 5).

In the discharge abnormality detection processing, the printer control portion 107 uses the detection portion 110 so as to sequentially move a detection range by one block in the main scanning direction, and thereby detects, by one block, whether or not the check line 212 in the check pattern 21 is present by whether or not the densities of pixels detected with the detection elements 1101 are density values which exceed a predetermined threshold value, and based on the position of the detected check line 212 within the one block in the main scanning direction, the moved position of the subsequent block is corrected.

In the configuration of the inkjet recording device 100 of the third embodiment, even when dust, dirt or the like present on the sheet P is detected as the check line 212, based on the position of the proper check line 212 within the one block of the subsequent movement destination, the moved position is corrected in the further subsequent block. In this way, it is possible to detect the position (discharge position) of the check line 212 without any error. Hence, even when any type of sheet P is used in the recording of the check chart 20 for detecting a discharge abnormality, it is possible to detect an abnormal ink discharge nozzle 1042 with high accuracy.

Although the embodiments of the present disclosure have been described above, the scope of the present disclosure is not limited to the embodiments, and various modifications are made without departing from the spirit of the invention and can be practiced.

What is claimed is:

1. A method of detecting a discharge abnormality in nozzles of an inkjet recording device, the method comprising:
a chart recording step of making a plurality of ink discharge nozzles arranged to be aligned along a main scanning direction in a recording head perform an operation of discharging an ink so as to record, on a recording medium, a check chart including a check pattern which is drawn with only the ink discharge nozzles;
a chart reading step of reading, with detection elements, the check chart recorded on the recording medium; and
a discharge abnormality detection step of determining an abnormality in the ink discharge nozzles by whether or not the check pattern is drawn in image data of the check chart read from the recording medium,
wherein in the check pattern of the check chart, among the ink discharge nozzles, a predetermined number of ink discharge nozzles in the main scanning direction are set to one block, and in each of the blocks, a plurality of check lines each of which is recorded with one of the ink discharge nozzles and which are extended along a subscanning direction are drawn such that each time the check lines proceed a predetermined length in the subscanning direction, the check lines are sequentially shifted line by line in the main scanning direction,
the discharge abnormality detection step includes a line detection step of detecting, by the one block, with the detection elements, whether or not the check line in the check pattern is present and
in the line detection step, a detection range is sequentially moved by the one block in the main scanning direction, whether or not the check line is present is detected with the detection elements and based on a position of the detected check line within the one block in the main scanning direction, a moved position of the subsequent block is corrected.

2. The method of detecting a discharge abnormality in nozzles of an inkjet recording device according to claim 1,
wherein when the position of the check line which is detected with the detection elements is on an upstream side in a detection movement direction with respect to a center portion within the one block in the main scanning direction, the moved position of the subsequent block is corrected to be on the upstream side whereas when the position of the check line is on a downstream side in the detection movement direction, the moved position of the subsequent block is corrected to be on the downstream side.

3. The method of detecting a discharge abnormality in nozzles of an inkjet recording device according to claim 1,
wherein based on an average value calculated with the positions of the check lines detected with the detection elements within blocks which have been most recently moved a plurality of times, the moved position of the subsequent block is corrected.

4. The method of detecting a discharge abnormality in nozzles of an inkjet recording device according to claim 1,
wherein the one block is partitioned into three regions of an upstream portion, a center portion and a downstream portion in the main scanning direction, and when the position of the check line which is detected with the detection elements is in the center portion, the moved position of the subsequent block is not corrected.

5. The method of detecting a discharge abnormality in nozzles of an inkjet recording device according to claim 1,
wherein in the line detection step, whether or not the check line is present is detected by whether or not a density of a pixel detected with the detection elements is a density value which exceeds a predetermined threshold value, and
the position of the check line is a position of a pixel in a center in the main scanning direction among pixels whose density values exceed the threshold value.

6. The method of detecting a discharge abnormality in nozzles of an inkjet recording device according to claim 1,
wherein in the line detection step, whether or not the check line is present is detected by whether or not a density of a pixel detected with the detection elements is a density value which exceeds a predetermined threshold value, and
when a certain number or more of pixels whose densities exceed the threshold value are detected within the one block, the check chart is recorded again.

7. The method of detecting a discharge abnormality in nozzles of an inkjet recording device according to claim 1,
wherein the check charts are individually recorded on a plurality of the recording media, and when an abnormality is detected in the same pixels in the check charts on the recording media, it is determined that the ink discharge nozzle corresponding to the pixel is abnormal.

8. An inkjet recording device comprising:
a transport portion that transports a recording medium;
a recording portion that is arranged opposite the recording medium transported with the transport portion, that includes a recording head in which a plurality of ink discharge nozzles are aligned along a main scanning direction and that discharges an ink to the recording medium;
a detection portion that includes detection elements which are arranged opposite the recording medium transported with the transport portion and that detects whether or not the ink discharged with the recording portion to the recording medium is present; and
a control portion that controls operations of the transport portion and the recording portion,
wherein the control portion makes the ink discharge nozzles perform an operation of discharging the ink so as to record, on the recording medium, a check chart including a check pattern drawn with only the ink discharge nozzles, makes the detection elements read the check chart and determines an abnormality in the ink discharge nozzles by whether or not the check pattern is drawn, and
in the control portion, among the ink discharge nozzles, a predetermined number of ink discharge nozzles in the main scanning direction are set to one block, in each of the blocks, a plurality of check lines each of which is recorded with one of the ink discharge nozzles and which are extended along a subscanning direction are drawn such that each time the check lines proceed a predetermined length in the subscanning direction, the check lines are sequentially shifted line by line in the main scanning direction, the check chart including the check pattern where the check lines are drawn is recorded, the detection portion is used to sequentially move a detection range by the one block in the main scanning direction so as to detect, by the one block, with the detection elements, whether or not the check line in the check pattern is present and based on a position of the detected check line within the one block in the main scanning direction, the moved position of the subsequent block is corrected.
